(19) United States
(12) Patent Application Publication
(10) Pub. No.: US 2020/0107978 A1
(43) Pub. Date: Apr. 9, 2020

(54) PATIENT SUPPORT DEVICE AND METHOD FOR ADJUSTING THE POSITION OF A PATIENT

(71) Applicant: MEGIN OY, Helsinki (FI)

(72) Inventor: Pasi LAINE, Helsinki (FI)

(73) Assignee: MEGIN OY, Helsinki (FI)

(21) Appl. No.: 16/484,038

(22) PCT Filed: Feb. 6, 2018
(86) PCT No.: PCT/EP2018/052868

§ 371 Date: Aug. 6, 2019

(30) Foreign Application Priority Data
Feb. 6, 2017 (FI) 20175101

(51) Int. Cl. A61G 5/10; A61G 5/12

(52) U.S. Cl. CPC A61G 5/1067; A61G 5/127

(57) ABSTRACT

A patient support device for positioning the patient including a support frame and a chair connected to each other, wherein the chair includes a seat portion and a back portion connected to each other. The back portion is extending upward from the seat portion The back portion further includes two opposite ends, a first end and a second end and the back portion is connected at the second end to the seat portion The first end of the back portion determines horizontal axis A. The first end of the back portion is pivotally connected to the frame by a rotating mechanism so that the chair is arranged to rotate around axis A.

### FIELD OF THE INVENTION

The present invention relates to a device for supporting and positioning a patient and to a method for adjusting the positioning of a patient.

### BACKGROUND OF THE INVENTION

Many medical procedures are uncomfortable for a patient and require patient to remain still for long times. Therefore, it is important that the patient can be placed in a comfortable position, by adjusting the supporting device like medical chair or bed, to minimize unnecessary movement. Also some medical procedures (i.e. magnetic field imaging) require that the patient holds the position throughout the procedure to ensure a reliable measurement.

Current patient supporting devices comprise a chair which is attached to a movable frame structure. Typically the chair comprises a horizontal seat portion for supporting the weight of the patient and a back portion supporting a back of the patient. These portions are connected to each other by a joint structure and the back portion can be inclined by rotating the back portion around the joint structure. For example a brain imaging requires that the head of the patient is still during the scanning process. With this current patient support device, patient is first positioned and the chair is adjusted. Then the patient slides his head into the helmet of an imaging device. If the patients position is not comfortable he needs to slide his head out of the helmet and the chair needs to be adjusted again. After readjusting the patient slides his head back into the helmet. This is done as many times as is necessary and it may take a lot of time.

### Objective of the Invention

The objective of the invention is to alleviate the disadvantages mentioned above.

In particular, it is an objective of the present invention to provide patient support device in which the patient position may be adjusted while the patients head remains substantially still.

### SUMMARY OF THE INVENTION

According to a first aspect, the present invention provides a patient support device for positioning the patient comprising a support frame and a chair connected to each other. The chair comprises a seat portion and a back portion connected to each other, which back portion is extending upward from the seat portion. The back portion further comprises two opposite ends, a first end and a second end, and the back portion is connected at the second end to the seat portion. The first end of the back portion determines horizontal axis A. The first end of the back portion is pivotally connected to the frame by a rotating mechanism so that the chair is arranged to rotate around axis A. The rotating mechanism may comprise joint or joints, wheels, rolls, pins etc.

In an embodiment of the invention, the frame comprises at least one first guiderail whereto the seat portion is connected. The seat portion may comprise wheels or rolls or pins, which are arranged into the first guiderail or rails.

In an embodiment of the invention, the back portion and the seat portion are pivotally connected to each other. Connection between the back portion and the seat portion may comprise joint or joints.

In an embodiment of the invention, the seat portion is arranged to move linearly along the first guiderail or rails so that the angle between the seat portion and the horizontal plane does not change.

In an embodiment of the invention, the frame comprises second guiderails whereto the rotating mechanism is connected. The rotating mechanism may comprise joints or hinges or just wheels or pins arranged into a guiderail.

In an embodiment of the invention, the rotating mechanism is arranged to move linearly along the second guiderails.

In an embodiment of the invention, the device comprises hydraulic transmission system arranged to rotate the chair around axis A. The hydraulic transmission system may comprise pumps, valves, hoses etc.

In an embodiment of the invention, the hydraulic transmission system is manually operated. Medical devices may be very large and heavy. When positioning the patient for a treatment or a procedure, there is always risk of malfunction or some kind of error in systems (electric devices etc.) which may cause damages to the patient. By using manually operated system, a user is constantly in control and is able to react. The system may comprise pedals or levers, which are arranged to control the hydraulic transmission system.

In an embodiment of the invention, the hydraulic transmission system is arranged to use water as a fluid. Water is safe hydraulic fluid when the hydraulic system is used in critical conditions wherein a leaking of the fluid could cause slipping or other dangerous situations.

In an embodiment of the invention, the hydraulic transmission system is connected to the seat portion. The hydraulic transmission system may comprise for example a piston, which is connected to the seat portion, and which back and forth movement adjusts also the seat portion back and forth.

According to a second aspect, the present invention provides a method for adjusting the position of a patient using a patient support device according to any of preceding embodiments. The chair inclination is adjusted by rotating the chair around the horizontal axis A, whereby the head of the patient remains substantially at the same place when the chair is inclined.

In an embodiment of the invention, the chair is adjusted hydraulically.

In an embodiment of the invention, the adjusting is done manually.

In an embodiment of the invention, the inclination is adjusted after the patient is placed for the treatment.

In an embodiment of the invention, only the back portion is inclined. The inclination of the back portion is adjusted preferably 5-20 degrees.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIGS. 1-3 show a schematic view of the patient support device, wherein the inclination of the chair is different in each figures.

### DETAILED DESCRIPTION OF THE INVENTION

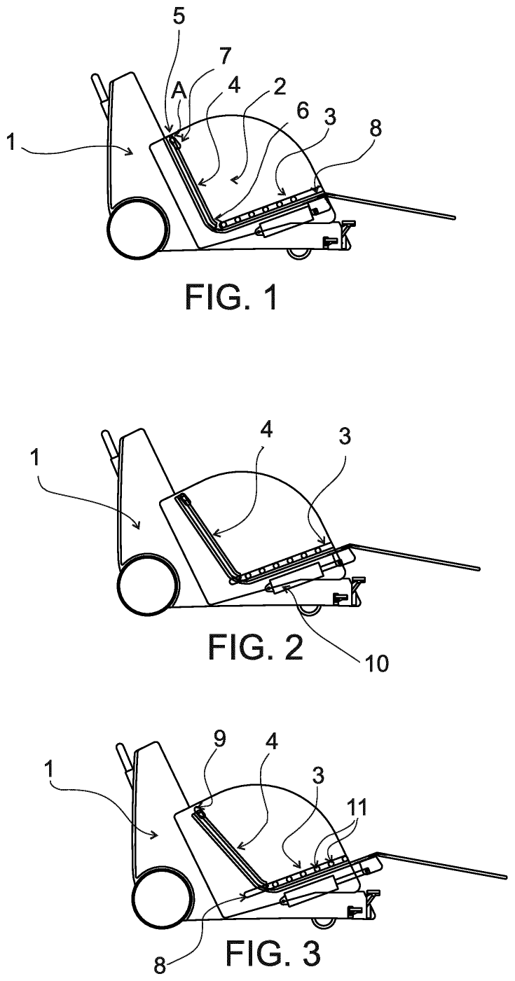

FIG. 1 shows a side view of a patient support device comprising main parts, a frame 1 and a chair 2. The chair 2 comprises a seat portion 3 and a back portion 4, which are connected to each other. The back portion 4 comprises a first end 5, which is the upper end of the back portion 4, and a second end 6, which is the lower end of the back portion 4. The back portion 4 is connected at the second end 6 to the seat portion 3. Usually they are connected to each other pivotally by joint or joints so that they are rotatable around their connection point. However, it is to be understood that the connection between the seat portion 3 and the back portion 4 may be rigid. The first end 5 determines an axis A, which is shown as a point in FIG. 1. The chair is arranged to rotate around this axis A so that the inclination of the back portion may be adjusted.

In FIG. 1, the chair 2 is in its upper position and the angle between the horizontal plane and the back portion 4 is at a maximum.

FIG. 2 shows a side view of the patient support device 1. In this view of the embodiment, the chair 2 is rotated counterclockwise, around the axis A (see FIG. 1), and the chair 3 is more inclined. In FIG. 2, the patient support device comprises also hydraulic transmission system 10, which is connected to the seat portion 3. In the hydraulic transmission system 10, the piston is arranged to move linearly back and forth, and move the seat portion 3 at the same time.

FIG. 3 shows a side view of the patient support device 1. In this embodiment, the chair is rotated more (comparing to FIGS. 1 and 2) counterclockwise, still around the axis A, and the chair 3 is even more inclined. In FIG. 3, the frame 1 comprises a first guiderail 8, whereto the seat portion 3 is connected. The guiderail may also be located under the seat portion 3, or the frame 1 may comprise several first guiderails 8, for example on both sides of the seat portion. In this embodiment, the seat portion comprises wheels 11, which are arranged into the first guiderail 8 so that the seat portion 3 may move linearly along the first guiderail 8. The frame 1 may comprise several first guiderails, which each of the first guiderails 8 is arranged to receive one wheel 11 (or roll or pin) of the seat portion 3. In FIG. 3, the guiderail 8 is shown as a straight rail, but the first guiderail(s) may have different shape, for example they may be curved. FIG. 3 shows also a second guiderail 9 in frame 1. The first end 5 of the back portion 4 is connected to the second guiderail 9 by the rotating means 7. In this embodiment, the rotating means comprises wheels connected to the first end 5 of the back portion 4 so that the center points of the wheels are on axis A. Consequently, the back portion 4 is rotatable around said axis A. These wheels are further arranged into the second guiderails 9 so that they are movable along the second guiderails 9.

In FIGS. 1 to 3, the chair 2 is rotated so that the angle between the seat portion 3 and the horizontal plane does not change, and the seat portion 3 is moved linearly along the guiderail 8. Therefore, the back portion 4 is moved a bit downwards so that the rotating means 7 are moved along the second guiderails 9. However, the rotating of the chair 2 may be arranged so that the rotating means 7 and the back portion 4 does not move downwards, but the seat portion 3 moves upwards a bit. In this kind of scenario, the first guiderails needs to have different shape (e.g. curved).

Although the invention has been the described in conjunction with a certain type of device or method, it should be understood that the invention is not limited to any certain type of device. While the present inventions have been described in connection with a number of exemplary embodiments, and implementations, the present inventions are not so limited, but rather cover various modifications, and equivalent arrangements, which fall within the purview of prospective claims.

1. A patient support device for positioning a patient while the head of the patient remains substantially at the same place comprising a support frame and a chair connected to each other, wherein
the chair comprises a seat portion and a back portion connected to each other, which back portion is extending upward from the seat portion;
the back portion further comprises two opposite ends, a first end and a second end, and the back portion is connected at the second end to the seat portion;
the first end of the back portion determines horizontal axis A,
wherein the first end of the back portion is pivotally connected to the frame by a rotating mechanism so that the chair is arranged to rotate around axis A.

2. The patient support device according claim 1, wherein the frame comprises at least one first guiderail whereto the seat portion is connected.

3. The patient support device according to claim 1, wherein the back portion and the seat portion are pivotally connected to each other.

4. The patient support device according to claim 2, wherein the seat portion is arranged to move linearly along the first guiderail or rails so that the angle between the seat portion and the horizontal plane does not change.

5. The patient support device according to claim 1, wherein the frame comprises second guiderails whereto the rotating mechanism is connected.

6. The patient support device according to claim 5, wherein the rotating mechanism is arranged to move linearly along the second guiderails.

7. The patient support device according to claim 1, wherein the device comprises a hydraulic transmission system arranged to rotate the chair around axis A.

8. The patient support device according to claim 7, wherein the hydraulic transmission system is manually operated.

9. The patient support device according to claim 7, wherein the hydraulic transmission system is arranged to use water as a fluid.

10. The patient support device according to claim 7, wherein the hydraulic transmission system is connected to the seat portion.

11. A method for adjusting the position of a patient using a patient support device according to claim 1, wherein the chair inclination is adjusted by rotating the chair around the horizontal axis A,
whereby the head of the patient remains substantially at the same place when the chair is inclined.

12. The method for adjusting the position of a patient according to claim 11, wherein the chair is adjusted hydraulically.

13. The method for adjusting the position of a patient according to claim 11, wherein the adjusting is done manually.

14. The method for adjusting the position of a patient according to claim 11, wherein the inclination is adjusted after the patient is placed for the treatment.

15. The method for adjusting the position of a patient according to claim 11, wherein only the back portion is inclined.
